(19) United States
(12) Patent Application Publication
(10) Pub. No.: US 2007/0228778 A1
(43) Pub. Date: Oct. 4, 2007

(54) Concealment device for vehicle roofs with at least one transparent part

(75) Inventors: Carlos Selgas Caceres, (US); Ruben Martinez Saldana, (US); Juan Carlos Sadornil Santamaria, (US)

Correspondence Address: WILLIAM COLLARD;COLLARD & ROE, P.C., 1077 NORTHERN BOULEVARD, ROSLYN, NY, 11576, US

(73) Assignee: GRUPO ANTOLIN-INGENIERIA, S.A.

(21) Appl. No.: 11/649,920

(22) Filed: Jan. 4, 2007

(30) Foreign Application Priority Data
Apr. 1, 2006 (EP) 06381001.4

(51) Int. Cl. B60J 7/00

(52) U.S. Cl. 296/214

(57) ABSTRACT

This invention consists of a concealment device for vehicle roofs consisting of two parts: a moving cross member and the concealment element itself. Both are connected by a temporary joint such that they can be moved together as a single body or can be separated to allow them to move separately. The possibility of separating them allows the removal of the rear concealment element, keeping the mobile cross member in its position, which carries the sun shades among other devices. It is also possible to remove both elements, leaving a cabin with a very large transparent element that may even be the extension of the windscreen. The means that allow its operation on diverging guides are also included in the subject of this invention.

### PURPOSE OF THE INVENTION

This invention consists of a concealment device for vehicle roofs with at least one transparent part that can be opened by a sliding lateral guides.

The purpose of this invention is a concealment device consisting of two parts: a first concealment part consisting of a resistant structure in the form of a moving cross member and a second, rear concealment part. The first concealment element is a structural part which at the same time forms the trim for the interior of the vehicle with a suitable design to allow sliding using the same rails as the concealment part, with sufficient means for retention and above all to prevent pitching to achieve the suitable coupling and connection with the rear concealment element. The first concealment element in the form of a moving cross member and the rear concealment element are connected with a temporary joint such that they can move together with as a single body or independently to allow them to slide separately.

The possibility of separating them allows the removal of the rear concealment part, maintaining the first concealment part in its position among the other sun roof parts, or, both elements can be removed, leaving the cabin with one large transparent part which may even be the extension of the windscreen. The second concealment part will be able to move in a limited way between the first concealment part and its storage location, which is fixed.

The purpose of this invention also includes the means that allow it to operate on diverging guides.

### BACKGROUND TO THE INVENTION

There is a growing trend to include ever-larger transparent elements in vehicles such that the user has the sensation of greater space and greater visibility to the exterior.

However, the presence of a larger transparent part also implies a higher level of solar radiation inside so that is necessary to insert a means of concealment that totally or partially covers the area of the transparent part.

There are various means of concealment adapted to the geometrical conditions of both the transparent part and of the lateral guides on which it slides to allow it to be opened.

Patent number EP1449692 describes a concealment element that allows the movement, adapting itself to the configuration imposed by the use of divergent guides; that is, while they may be parallel in their initial section of movement in the rear part, they separate in their frontal part with greater distances between guides.

The technical solution used to adapt the concealment device to these guides consists of the use of a rigid structure consisting of a telescopic transverse frontal bar with others that may be necessary in intermediate sections. These rigid telescopic bars match the different distances between the guides in their movement and maintain rigid a flexible sheet that can be stretched during its extension to match the various configurations.

This configuration has various inconveniences. The first is the practical difficulty of sliding manually since the tension of the elastic sheet in the diverging area causes reaction forces that tend to move the assembly of elements in the device longitudinally. This tendency to sliding either requires braking or during the manual movement an important effort needs to be applied which frequently makes its application unviable.

The second inconvenience is the impossibility of adopting certain degrees of curvature since, because it is an elastic sheet, it tends to adopt the form required by the distribution of tensions and it is never possible to follow a domed form when there is a pronounced double curve.

Patent number DE10331271 describes another concealment element consisting of rigid sections fixed to the concealment device. These rigid elements are the ones that move along the lateral guides and are telescopic to adapt themselves to divergent guides.

The same invention considers special cases in which the concealment element is divided into two parts, one for the right side and the other for the left side; or even more general situations of movement always using telescopic means for the rigid structure of the concealment element.

Patent number DE10338722 describes an extending concealment element using a rigid frontal cross member which has a support at the end that acts as a rocker that can adapt itself to the diverging line of the guides.

This rocker pivots on a point at its junction with the cross member with two points that slide following the guide. The junction of the cross member with the concealment element allows its sliding movement to drag the concealment element. If the sun shades are joined to this cross member, the movement of the concealment element will necessarily move the sun shades because they move together with the concealment element as it is moved.

Patent number DE19856868 is given as an example of the combination of independent concealment elements. In this patent, the front concealment element does not replace the trim containing elements such as the rear-view mirror or sun shade but retains the usual trim, with fixed installation, separating the roof and the windscreen.

Finally, patent number EP1405745 is mentioned because it defines a moveable sliding support consisting of a bar for sliding the sun shades only. This bar does not replace the trim and is no more than a simple structure that slides independently without in itself forming a concealment element. Neither is it limited in its movements by the single concealment element it describes but does include the possibility of crossover between both.

The main purpose of this patent is to establish a means of moving the sun shades to the rear part of the vehicle.

### DESCRIPTION OF THE INVENTION

This invention consists of a concealment device for vehicle roofs with at least one transparent element consisting of two parts or concealment elements, a first concealment element called, for the purposes of differentiation, the mobile cross member and which is no more than a rigid frontal structure that allows the trim to support the sun shades among other auxiliary elements; and a second part consisting of the rear concealment element which, from this moment on, is called the “concealment element” not because it is the only one but because it is closer to what is usually a concealment element.

The two bodies can be separated, giving rise to two situations during use: the first in which the mobile cross member and the concealment element are joined and act as a single unit, and a second in which they are separated and may be in different positions.

This invention is of great interest for use in large areas such as those formed by a windscreen that extends continuously as a transparent element in the vehicle's roof.

In this configuration, a support is required for the sun shades and this support, although moved towards the rear of the concealment element, may also be present in order to house the sun shades and other auxiliary elements normally housed in the trim between the windscreen and the roof.

When with the mobile cross member is joined to the concealment element and the entire device is in its forwardmost position, it provides a configuration that is similar to that of a traditional vehicle which at the front has the sun shades together with the other trimmer elements and the roof is open.

The removal of the concealment element will also remove the mobile cross member and therefore the sun shades and other auxiliary elements that may be installed on this cross member.

This solution is valid when the entire transparent area is to be made available, both that of the windscreen and that of the transparent extension in the roof. Nevertheless, the front seat occupants may require the sun shade and at the same time may want to remove the concealment element.

This invention allows this intermediate situation since, because it is possible to separate the mobile front cross member from the concealment element, the former may remain in the front part of the vehicle and the concealment element may be withdrawn. Not only are these extreme arrangements possible but any intermediate one is possible too since the movement of one or other body is independent, whether manually or power-operated. In all situations, both extreme and intermediate, the rear concealment element is limited in its movement between the rear edge of the transparent elements and the position of the mobile cross member.

The mobile cross member is a structure that replaces the usual fixed trim located between the windscreen and the roof so that it must incorporate the necessary strengthening elements to continue to fulfil both its support function and its concealment function due to its area of extension.

Although the invention is able to function by sliding in parallel guides, the mobile cross member is a rigid structure whose side supports can be adapted to the increase in distance and changes in curvature imposed by diverging guides.

This adaptation is possible because its ends include mobile support pieces that can be structural in nature. One of the examples described in detail makes use of pieces that are called from now on triangles.

These triangles are rigid pieces that are partially housed inside the mobile cross member such that they can move in and out within a certain range of distances in a movement that is parallel to the main plane defined by the body of the mobile cross member. These in and out movements occur without the loss of the resistant support capacity offered in the direction perpendicular to the plane in which they can move.

The in and out movement may be complicated to allow the position of the triangle to adapt to the position imposed by the divergent guides. This in and out movement of the triangle is guided using the most general case for following a given curve. This curve sets a movement with an instantaneous centre of rotation that also moves according to its own trajectory causing movements that may even be complicated ones from the kinematic point of view.

In the simplest case in which the curves are segments of a circumference with a common centre, this instantaneous centre of rotation may match the physical axis that structurally reinforces the connection between the triangles and the mobile cross member. In this specific case, the movement of the triangles is simply a rotation around the physical axis.

If this is the connection between the triangle and the mobile cross member, there is another connection between the triangle and the guide that consists of the use of sliding cars and bars such as those usually used in the movement, for example, of sheets for use as the concealment element. These auxiliary elements ensure a correct sliding, minimising wear and rubbing.

The purpose of the invention also includes the use of other structural solutions to cover the additional space caused by the divergence of the guides. These are based on configurations consisting of independent telescopic elements, for example, cylinders guided in housings, which in turn reach the bars that slide in the guides.

The connection of these telescopic elements with the bars that slide in the guides may be carried out by one or more points to allow the bar the necessary rotation between the bar and the telescopic elements required by the change of direction caused by the diverging guide.

On the other hand, the concealment element consists of a sheet or plate with sufficient area to cover the rest of the transparent element or the transplant elements if there is more than one. It has already been stated that this concealment element can be separated from the mobile cross member, for which it has the means for connecting and coupling to that mobile cross member on its front edge.

Given that the shape adopted by the transparent element may be very varied with longitudinal and transfers curvatures that may be pronounced or not, concealment elements of flexible, semi-flexible and rigid materials are used.

Flexible materials refers to a sheet that must be kept in tension in order to avoid wrinkling and semi-flexible refers to materials that may have a certain degree of bending, in the longitudinal sense, transverse sense or both, but that may, for example, supports shearing tensions and operating forces.

In each case, the sheets or reinforcement elements required by the material used in the main area of the concealment element and guides are used and there are also bars, cars and sliding elements in the guide as well as the traction elements, either manual or powered.

The connection between the mobile cross member and the concealment element is made using a anchoring that can be separated from inside the vehicle. The detailed description of the invention describes the practical manufacture of an anchoring that allows the connection simply by applying a force to bring them together and separation facilitated by a manual control that frees the mechanical retention.

### DESCRIPTION OF THE DRAWINGS

This description is complemented with a set of plans illustrating the preferred example and never limiting the invention.

FIG. 1 is an exploded view of a first example for manufacturing the invention including the guides and movement motors.

FIG. 2 shows a sequence of three phrases of movement of the concealment device when the mobile cross member and the concealment element are connected and another sequence, shown below the first one, which includes the movement of the concealment element with the mobile cross member disconnected and arranged without moving the front part.

FIG. 3 shows an exploded view of the concealment element according to a manner of manufacturing the invention in which a semi-flexible sheet is used.

FIG. 4 shows an exploded view of the concealment element according to another manner of manufacturing the invention in which a rigid sheet or plate is used.

FIG. 5 shows an exploded view of the mobile cross member according to one manner of manufacturing the invention.

FIG. 6 shows a detail of the fixing and support of the lateral triangles of the mobile cross member in the same manner of manufacturing the invention.

FIG. 7 shows a second mode of configuring the triangles on the mobile cross member.

FIG. 8 shows another method of fixing the freeze to the guide using two support points.

FIG. 9 shows a sequence of joining and freeing the mobile cross member and the concealment element according to one manner of manufacture.

### EXAMPLES OF MANUFACTURING THE INVENTION

In this detailed description of examples of the invention, use will be made of a descriptive order which starts from the components in an example of manufacturing the invention and then indicates modes for relating each of them together. According to this descriptive order, the elements directly related with the essence of the invention need not be at the start. Equally, the names of the mobile cross member (1) for the concealment element given previously that consists of a cross member and the name of the concealment element (2) will be retained.

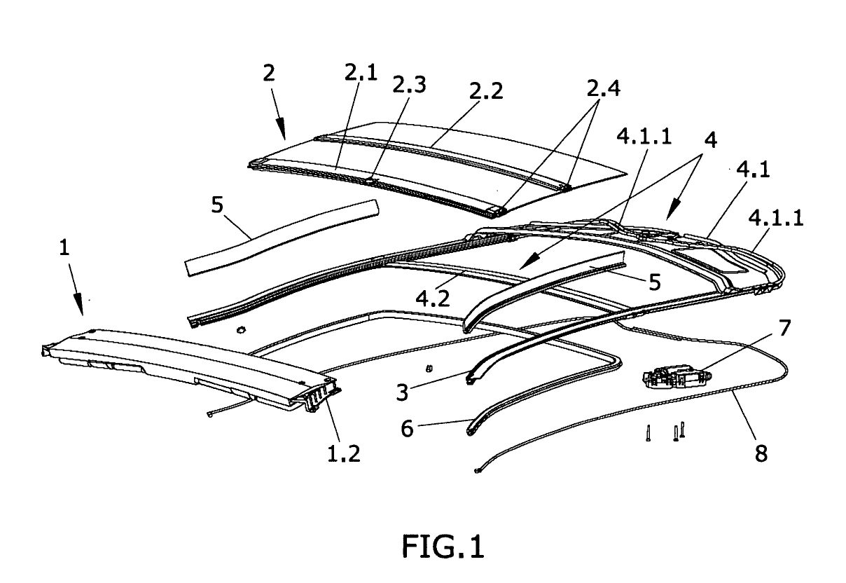

FIG. 1 is an exploded view of an example of manufacturing the invention to show which components form the device.

This figure shows the lateral guides (3) connected by cross beams (4), in this case a rear one (4.1) and an intermediate reinforcing one (4.2) forming the support structure on which the device that forms the subject of this invention will slide.

As well as the guides (3), a gasket (6) is shown below as well as a trim (5) above which in this example of manufacturer serves to hide part of the elements of the device, leaving visible only the essential elements.

In this case the invention has a support frame essentially consisting of the guides (3), the rear cross beam (4.1) and the intermediate beam (4.2). The rear beam (4.1) may be metal or injected plastic. In this case it is possible to integrate into the body of the rear cross beam (4.1) both the tubes (4.1.1) that guide the cables (8), the anchoring of these tubes to the motor (7), the motor support (7) and the anchorings for the tubes to the guides (3). In this case the anchorings of the tubes are supported as is done normally, defining channelled sections that alternatively protrude to one side and the other to clamp the tube, also alternatively, using a form that can be injection-moulded. The ends of the tubes that reach the cross beam and other ends are anchored with additional pieces that may also be of plastic.

The mobile cross member (1) and the concealment element (2) are shown separated, with one (1) and another (2) means of coupling for use as a single body and both (1, 2) sliding in the same guides (3).

The same FIG. 1 shows a forward transverse reinforcement (2.1) in the concealment element (2) coinciding with the edge that couples with the mobile cross member (1) and a second central reinforcement (2.2) which, if semi-flexible sheets are used, serves to increase the rigidity so that the concealment surface better matches the geometrical configuration and curvature of the transparent surface to be covered.

It is in the rear reinforcement (2.1) where the retention means or joint (2.3) with the mobile cross member (1) can be seen that allows the mobile cross member (1) and concealment element (2) to slide in the guides as a single body. It is important in this mutual joint that the surfaces that come into contact match. The greatest difficulty in the coupling is the possibility of pitching of the mobile cross member (1). This pitching is mainly prevented by the various aspects of its design; one is its width, understood as the distance or average measurement between the front and rear parts with respect to the vehicle, and another important one is the use of lateral guiding means, on one side and the other, which have at least two support points or one continuous support. The combined action of these technical properties allows the position of stability in pitch to be guaranteed.

This sliding is possible thanks to the manual movement of the device, or by a motorised movement. In the example shown in FIG. 1, a motor (7) is used, joined to the rear cross beam (4.1) from which the drive cables (8) reach either the mobile cross member (1) or the concealment element (2). This motorised movement may act on one or the other together or independently since when both elements (1, 2) are separate, the concealment element (2), for example, can be moved while the mobile cross member (1) remains braked on the front part so that, for example, the front passengers have a sun shade (1.1).

This same FIG. 1 shows on one end of the mobile cross member (1) a triangle (1.2) that serves as a support and that can adapt to the diverging guides (3). This element is described below with the help of the figures.

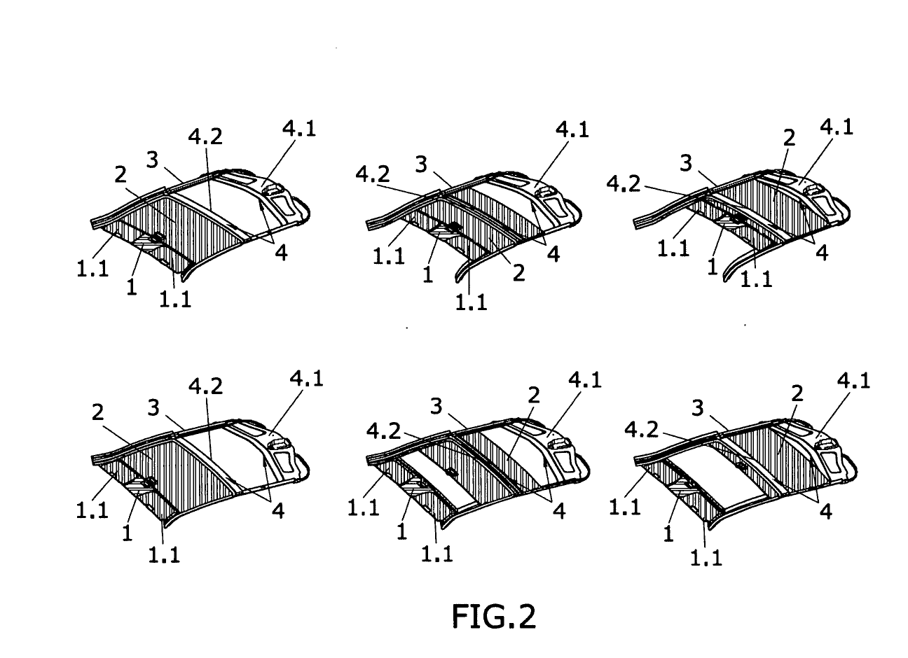

FIG. 2 shows a sequence of the movement of the device that forms the subject of this invention showing some of the possibilities for movement.

The upper row of figures shows the mobile cross member (1) and the concealment element (2) joined such that during the sliding they move as a single body. When the concealment element (2) is withdrawn, the mobile cross member (1) with the sun shades (1.1) also moves towards the rear part.

The lower row of figures shows the mobile cross member (1) separated from the concealment element (2). In this case, it is possible to keep the mobile cross member (1) in the front part of the area to be hidden with its sun shades (1.1) arranged for use and the concealment element (2) is moved separately to its rearmost storage position, limited by the presence of the rear cross beam (4.1).

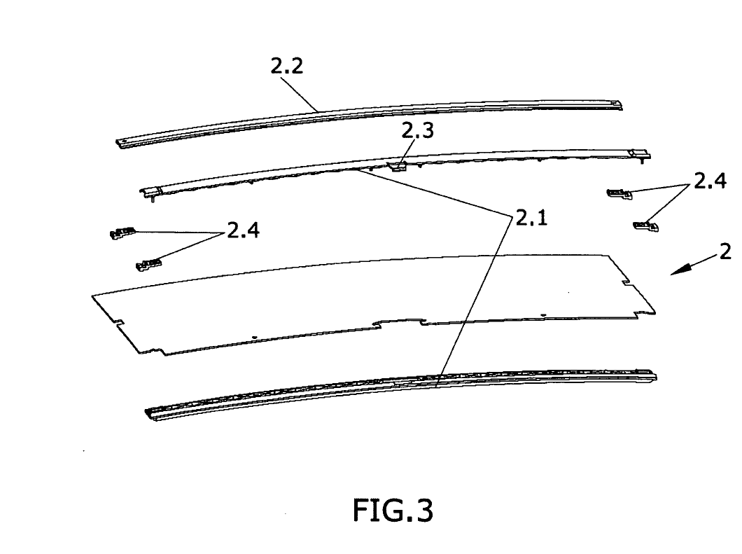

FIG. 3 shows an example of the concealment element (2) in an exploded view to provide a better view of one of its components.

This view shows the concealment element (2) in which the main sheet is semi-flexible because it admits bending around the main longitudinal and transverse axes but, for example, it cannot be rolled up and does not allow shearing forces.

Two pieces are joined above and below this sheet to provide reinforcement (2.1) to the front edge. In this example of manufacturing the invention, two pieces are used to give greater rigidity while it is possible to hide the reinforcement ribs of each piece behind the coupling in its final position. Nevertheless, it is also possible to use a single piece which (2.1) has the coupling means (2.3) to form the joint or connection with the mobile cross member (1). In FIG. 3, one of the reinforcements (2.1), the upper one, has a means of connection (2.3) in the form of a hook which engages in the corresponding hole in the mobile cross member (1). This hook (2.3) may be located in any of the reinforcement pieces (2.1). The details of the joint are given below.

Also shown are the transverse reinforcement (2.2) and the bars (2.4) that couple both the transverse reinforcement (2.2) and the reinforcement (2.1) on the front edge so that the assembly slides in the guide (3) of the concealment device.

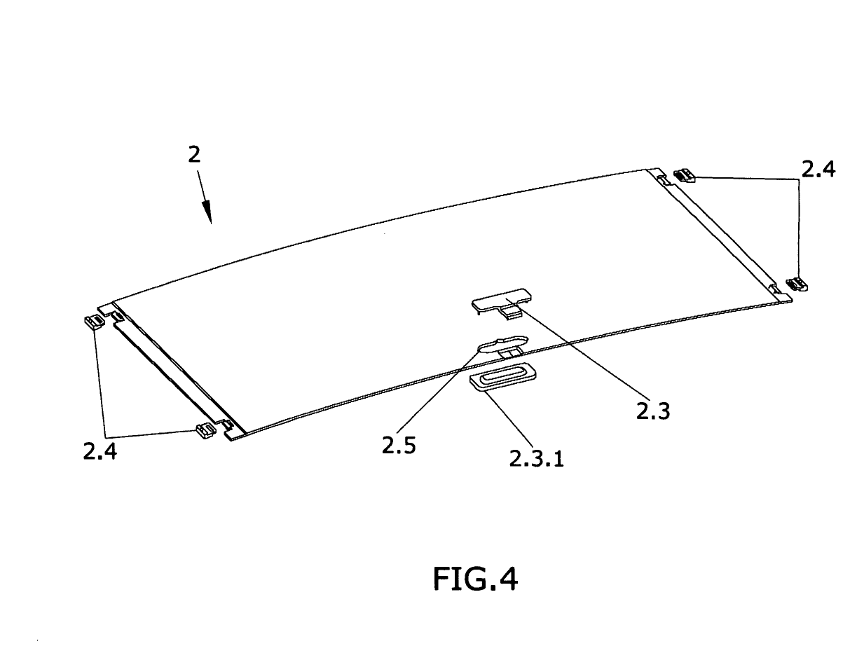

When the rigidity of the concealment element (2) is increased, it is possible, as shown in FIG. 4, to do away with the rigidity and reinforcement elements (2.1, 2.2) used in the above example.

In the example shown in FIG. 4, it is possible that the sliding bars (2.4) are fixed directly to the concealment element (2) since there are no transverse reinforcements.

At the front, also in this example, the joining or connecting means (2.3) with the mobile cross member (1) are housed in a perforation (2.5) in the concealment element (2). These means for connecting (2.3) include the handle (2.3.1) or mechanism that moves the sliding of the concealment element (2) along the guides (3).

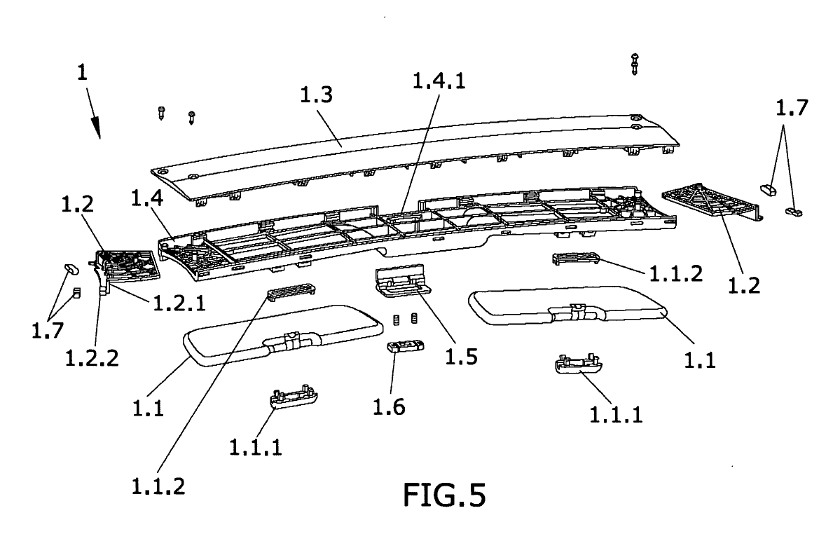

FIG. 5 also shows an exploded view of an example of the manufacturer of the mobile cross member (1). In this example, the main body consists of the two semi-covers, one semi-cover (1.3) above and one semi-cover (1.4) below, both joined, for example, using bolts and clips.

The main flat body of the triangles (1.2) is trapped between these semi-covers (1.3, 1.4) allowing the mobile cross member (1) to adapt to the distance and divergence imposed by the guides (3).

This triangle (1.2) has the above mentioned main flat body reinforced by a group of ribs, plus a stepped extension (1.2.1) in an arch that ends in a support bar (1.2.2).

The stepped extension (1.2.1) allows the mobile cross member (1) to assume a higher position than that which would be imposed by the triangle (1.2) if it was contained entirely in a plane.

The bars (1.7) that slide in the guide (3) are anchored on the support bar (1.2.2).

The various modes of kinematic dependency between the triangle (1.2) and the mobile cross member (1) are described below.

In this example, the sun shades (1.1) are located under the mobile cross member (1) where their joint with the mobile cross member (1) uses trims (1.1.2) finished with second trims (1.1.1) to complete the closure of the finished joint of the sun shades (1.1). In another possible manufacturing example, the sun shades (1.1) may be disposed of so that by extending the guides (3) at their front ends, the front concealment element or mobile cross member (1) carries out the function of the sun shades (1.1).

It can be seen that there is a slot (1.4.1) in the lower semi-cover (1.4) in the centre of the mobile cross member (1). This is the location of the connection with the concealment element (2) and the push button (1.6). FIG. 5 shows the push button (1.6) together with the trim (1.5). The push button (1.6) in this preferred form of manufacture in which the mobile cross member (1) moves under power and the concealment element (2) is mobile and manual, this push button serves only to free the concealment element (2). As described already, the description of a method of providing the joint or connection between the mobile cross member (1) and the concealment element (2) is given below with the help of a suitable cross section.

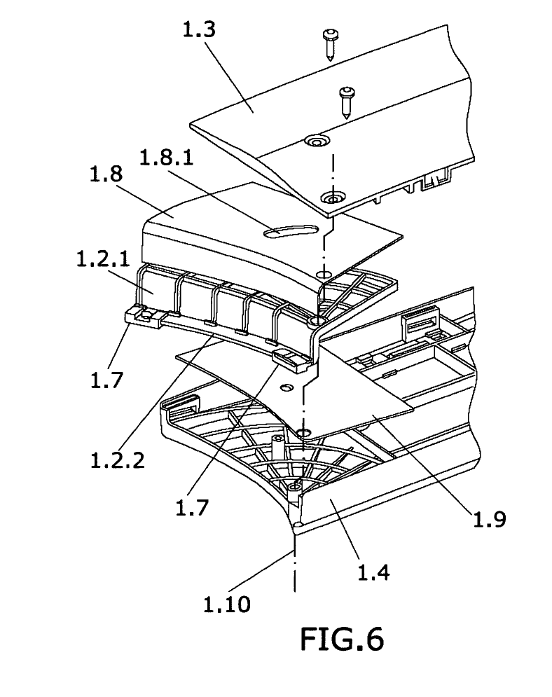

FIG. 6 shows a method of providing a joint between a triangle (1.2) and the main body of the mobile cross member (1) with additional pieces compared to the solution shown in FIG. 5.

In this configuration, various parts are enclosed between the upper semi-cover (1.3) and the lower semi-cover (1.4) that are involved in the relative movement between the triangle (1.2) and the mobile cross member (1).

This relative movement in this example is caused by a shaft located at the geometrical axis (1.10) shown as a dashed line. Above the triangle (1.2) there is an upper cover (1.8) and a lower cover (1.9), both in a material that facilitates fiction due to its low frictional coefficient and high resistance to fiction. Thus, it is the triangle (1.2) that offers sufficient resistance and support capacity in a set of reinforcement ribs.

The upper cover (1.8) contains a slot (1.8.1) that ensures the guidance in points away from the axis (1.10) of rotation. However, this slot (1.8.1) may be present also when the mobile cross member (1) requires a reinforcement, for example, using an intermediate bolt, such that the above-mentioned slot (1.8.1) allows the passage of the bolt without preventing the rotation of the triangle (1.2). This slot (1.8.1) has the form of an arch because this is the relative movement of the triangle (1.2) with respect to its fixed axis (10) of rotation.

A more general case may be considered consisting of various slots in the form of a specific curve that allows a more complicated relative movement between the triangle (1.2) and the mobile cross member (1). In this other case, the instantaneous centre of rotation need not be a fixed point requiring the presence of a mechanical axis but this instantaneous centre of rotation may also move. In this last case, the presence of a physical axis is not possible.

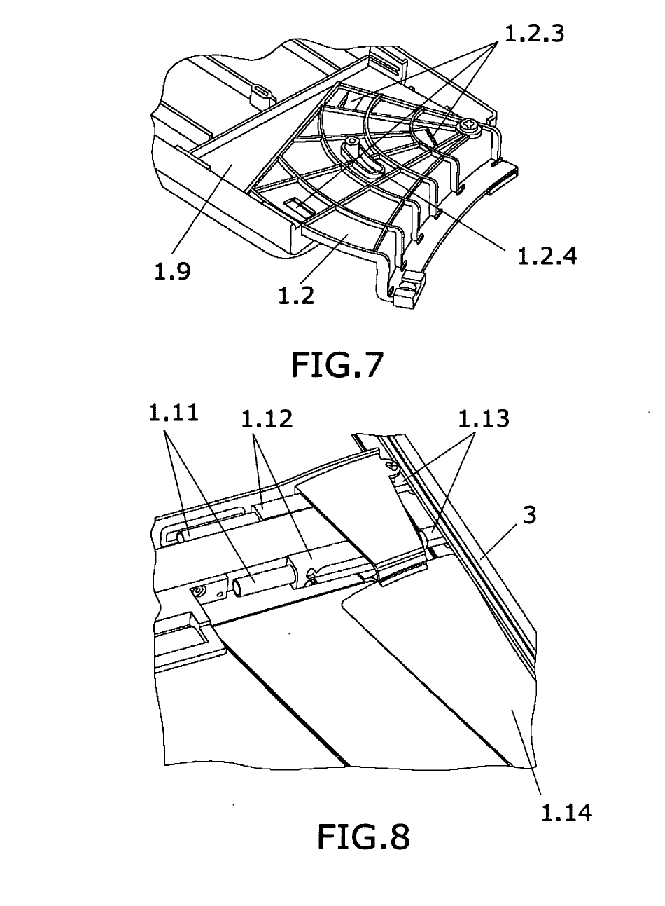

The sliding between the triangle (1.2) and the upper and lower pieces that delimit it, for example, the upper (1.8) and lower (1.9) covers, may be facilitated and improved by incorporating support bars (1.2.3) as shown in FIG. 7. These bars (1.2.3) are integrated into the triangle (1.2) itself as springs that provide pressure on the adjacent surface and thus prevent free play that could cause noise and malfunctioning.

In this same FIG. 7, the form of joining the triangles (1.2) to the mobile cross member (1) is different to the previous examples since there is a triangle (1.2) between the two covers (1.8, 1.9) that presses mainly against the lower one (1.9) as shown in the detailed cross section, and the slot (1.2.4) is in the triangle itself (1.2).

In this FIG. 7, the upper cover (1.8) is not shown; in order to shows suitably the details the view of the end of the mobile cross member (1), the pieces on the triangle (1.2) have been removed since they would otherwise cover it.

The triangles (1.2) need not be the only way of connecting a rigid mobile cross member (1) and the guide (3); sliding cylinders in bushes could be used, like those shown in FIG. 8. In FIG. 8 there are two cylinders (1.11) guided in a housing (1.12) so that they can only move longitudinally, in and out, independently. Bars (1.13) are fixed at their ends which join with the guide (3) as was the case with the triangle (1.2) in the previous examples with their bars (1.7). These bars (1.13) therefore connect at two points to each cylinder (1.11) which in turn have independent slides giving their bars (1.7) the degree of freedom necessary to adapt to the guide (3).

Although when the triangles (1.2) emerge they cover the additional space between the mobile cross member (1) and the guide (3), in this case an additional piece (1.14) must be included to cover the space. The additional piece (1.14) moves according to the cylinders (1.11) such that as it protrudes due to the increasing distance generated by the divergence of the guides (3), this triangle (1.2) opens to cover that space.

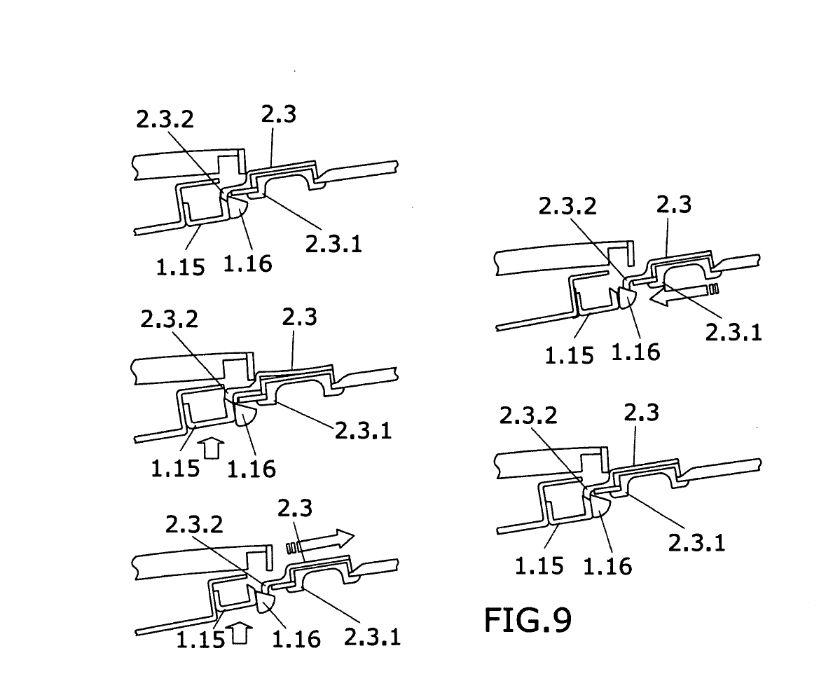

FIG. 9 is a detail of the joint that provides a temporary connection between the mobile cross member (1) and the concealment element (2). It is described as temporary because it may be joined or separated depending on whether the user wishes them to remain coupled together or not.

In this example of how the mobile cross member (1) and the concealment element (2) can be joined, use is made of a clip coupling that may be unhooked by pressing on the push button (1.15).

FIG. 9 shows two columns of figures. The right column shows the process of clipping and the left shows how they are separated.

Describing first the clipping process according to the figures in the right hand column, it can be seen that the concealment element (2) has one end (2.3.2) in the form of a hook on the main body (2.3) which is flexible. In this manufacturing example, the handle (2.3.1) is located underneath the body (2.3) to allow the concealment element to a pushed manually towards the mobile cross member (1).

When the concealment element (2) reaches the mobile cross member (1) it does so via the end (2.3.2) in the shape of a hook, coming up against a stop (1.16) with an oblique flat surface. This oblique surface causes the end (2.3.2) to slide over it, flexing thanks to the flexibility of the main body (2.3) to overcome it and engage behind it (1.16).

When the end (2.3.2) is anchored behind the stop (1.16), this end remains located on the operating push-button (1.15).

The group of figures in the left-hand column shows how pressing the push button (1.15) forces the fixing end (2.3.2) by bending so that it realigns with the oblique surface of the stop (1.16) freeing it thanks to the movement caused by the wedge support of the push button (1.15) and the end (2.3.2).

Once the stop (1.16) is freed, the concealment element (2) is freed and therefore liberated from the mobile cross member (1).

The means of connection between the mobile cross member (1) and the concealment element described by clipping may be different, such as rotating studs, one or other form of interlocking, without these different solutions affecting the essence of the invention.

Regardless of whether the mobile cross member (1) and the concealment element (2) are connected on not, both have means for blocking to fix the position with respect to the guides, either manually or motorised.

After seeing these examples of manufacturing the invention, it is possible to generalise the essential features of the invention, saying that it consists of a concealment device for vehicle roofs with at least one transparent element which consists of a concealment element situated in the front part of the vehicle and consisting of at least one mobile cross member (1) and a second concealment element (2) which complements the first one (1) to hide the entire transparent element in the roof so that both concealment elements can be separated and may be moved independently or together throughout the roof of the vehicle because both (1, 2) concealment elements slide on the same guides (3) and where the concealment element located in the front part consisting of a mobile cross member (1) verifying:
That it has guiding means on both sides.
That it is stable by itself, both in position and in pitch thanks to the combined action of its anchoring and the action of the lateral guiding means which either two support points or one continuous support.
That its position is always forward with respect to the position of the concealment element (2).
That it has a retention capacity with its own or external means of blocking.
That it is an essentially rigid structure. and the second concealment aliment (2) verifying:
That it has a store in the rear part.
That this store is fixed.
That when the connection is freed between both concealment elements (1, 2) the latter (2) may be moved independently of the front element (1) between it (1) and the rear edge of the transparent element.

1. Concealment device for vehicle roofs with at least one transparent element that consists of a concealment element located in the front of the vehicle consisting of at least one mobile cross member (1) and a second concealment element (2) which complements the first one (1) to hide all of the transparent element in the roof, such that both concealment elements can be separated and may be moved independently or together along the roof of the vehicle because both concealment elements (1, 2) slide on the same guides (3) and where the concealment element located in the front part consisting of a mobile cross member (1) verifying:
That it has guiding means on both sides.
That it is stable by itself, both in position and in pitch thanks to the combined action of its anchoring and the action of the lateral guiding means which either two support points or one continuous support.
That its position is always forward with respect to the position of the concealment element (2).
That it has a retention capacity with its own or external means of blocking.
That it is an essentially rigid structure.
and the second concealment aliment (2) verifying:
That it has a store in the rear part.
That this store is fixed.
That when the connection is freed between both concealment elements (1, 2) the latter (2) may be moved independently of the front element (1) between it (1) and the rear edge of the transparent element.

2. Concealment device for vehicle roofs with a transparent element as in claim 1 in which the guides (3) are parallel.

3. Concealment device for vehicle roofs with a transparent element as in claim 1 in which the guides (3) are divergent.

4. Concealment device for vehicle roofs with a transparent element as in claim 3 in which the mobile cross member (1) has means at its ends that allow the filling of the additional space created by the divergence of the lateral guides (3).

5. Concealment device for vehicle roofs with a transparent element as in claim 4 in which the means that allow the filling of the additional space caused by the divergence of the lateral guides (3) consists of configurations of a structural type.

6. Concealment device for vehicle roofs with a transparent element as in claim 5 in which the element that forms the structural configuration that covers the additional space caused by the divergence moves in the form of a curve.

7. Concealment device for vehicle roofs with a transparent element as in claim 6 in which the element that forms the structural configuration that covers the additional space caused by the divergence moves by rotation.

8. Concealment device for vehicle roofs with a transparent element as in claim 7 in which the element that forms the structural configuration that covers the additional space caused by the divergence is a triangle (1.2) with a rotation axis (1.10).

9. Concealment device for vehicle roofs with a transparent element as in claim 8 in which the triangle (1.2) has covers (1.8, 1.9) to improve friction and reduce rubbing, below, above or both simultaneously.

10. Concealment device for vehicle roofs with a transparent element as in claim 8 in which the triangle (1.2) has guide slots (1.2.4).

11. Concealment device for vehicle roofs with a transparent element as in claim 8 in which the triangle (1.2) has support bars (1.2 0.3) that act as springs to facilitate the rotation.

12. Concealment device for vehicle roofs with a transparent element as in claim 8 in which the triangle (1.2) has bars (1.7) for sliding along the lateral guides (3).

13. Concealment device for vehicle roofs with a transparent element as in claim 5 in which the structural configuration that covers the additional space caused by the divergence moves due to the movement of independent elements.

14. Concealment device for vehicle roofs with a transparent element as in claim 13 in which the movement is carried out by two cylinders (1.11) guided in a housing (1.12) in a telescopic configuration which also has a piece (1.14) that is essentially triangular connected with the bars (1.13) to cover the additional space caused by the divergence of the guides (3) in which these bars (1.13) have two support points, one for each cylinder (1.11).

15. Concealment device for vehicle roofs with a transparent element as in claim 13 in which the movement is carried out by at least one cylinder (1.11) guided in a housing (1.12) in a telescopic configuration in which there is also a piece (1.14) that is essentially triangular connected with the bars (1.13) to cover the additional space caused by the divergence of the guides (3) in which these bars (1.13) have a single point of support, that of the cylinder.

16. Concealment device for vehicle roofs with a transparent element as in claim 1 in which the concealment element is rigid.

17. Concealment device for vehicle roofs with a transparent element as in claim 1 in which the concealment element is semi-flexible, allowing longitudinal and transverse bending but not shearing or rolling up.

18. Concealment device for vehicle roofs with a transparent element as in claim 1 in which the concealment element is flexible, allowing it to be rolled up.

19. Concealment device for vehicle roofs with a transparent element as in claim 18 in which the concealment element is a flexible panel or curtain that may optionally be fitted with pockets to hold the sheets.

20. Concealment device for vehicle roofs with a transparent element as in claim 1 in which the means of joining temporarily the mobile cross member (1) and the concealment element (2) are by clipping.

21. Concealment device for vehicle roofs with a transparent element as in claim 1 in which the mechanism to move the mobile cross member (1) and the concealment element is manual.

22. Concealment device for vehicle roofs with a transparent element as in claim 1 in which the mechanism to move the mobile cross member (1) and the concealment element (2) is motorised.

23. Concealment device for vehicle roofs with a transparent element as in claim 22 in which the motorised mechanism is independent for the mobile cross member (1) and for the concealment element (2).

24. Concealment device for vehicle roofs with a transparent element as in claim 1 in which the mobile cross member (1) and the concealment element (2) have means of blocking to fix the position with respect to the guides (3), these blocking means being either a manual or a motorised mechanism.

25. Concealment device for vehicle roofs with a transparent element as in claim 1 in which there is a support frame.

26. Concealment device for vehicle roofs with a transparent element as in claim 25 in which the support frame is of plastic made of one piece or of various assembled pieces.

27. Concealment device for vehicle roofs with a transparent element as in claim 26 in which the support frame is formed by guides (3), rear cross beam (4.1) and another intermediate beam (4.2).

28. Concealment device for vehicle roofs with a transparent element as in claim 27 in which the rear cross beam (4.1) is of metal.

29. Concealment device for vehicle roofs with a transparent element as in claim 27 in which the rear cross beam (4.1) is of plastic and in which the cable guide tubes and motor support (7) can be integrated.

30. Concealment device for vehicle roofs with a transparent element as in claim 1 in which the mobile cross member (1) is motorised and the concealment element (2) is moved manually.

31. Concealment device for vehicle roofs with a transparent element as in claim 1 in which the guides (3) are extended at the front sat so that the first concealment element of formed as a mobile cross member (1) also forms the sun shade.
